(19) United States
(12) Patent Application Publication
(10) Pub. No.: US 2026/0158832 A1
(43) Pub. Date: Jun. 11, 2026

(54) METHOD FOR ADJUSTING COMMUNICATION PARAMETERS BETWEEN A WHEEL UNIT AND AN AUTHORISED DEVICE

(71) Applicant: CONTINENTAL AUTOMOTIVE TECHNOLOGIES GMBH, Hannover (DE)

(72) Inventors: Nicolas GUINART, Toulouse (FR); Jean-Philippe BOISSET, Montauban (FR)

(73) Assignee: CONTINENTAL AUTOMOTIVE TECHNOLOGIES GMBH, Hanover (DE)

(21) Appl. No.: 18/721,700

(22) PCT Filed: Dec. 14, 2022
(86) PCT No.: PCT/EP2022/085771

§ 371 Date: Jun. 19, 2024

(30) Foreign Application Priority Data
Jan. 6, 2022 (FR) 2200088

(51) Int. Cl. B60C 23/04; B60C 23/20; G01K 3/00; G01L 17/00

(52) U.S. Cl. CPC B60C 23/0461; B60C 23/0479; B60C 23/20; G01K 3/005; G01L 17/00

(57) ABSTRACT

A method for adjusting at least one of the communication parameters from among the size of the communicated message or the periodicity of communication between a wheel unit and a remote monitoring and/or control device. Communication between the monitoring device and the wheel unit carried out according to a communication protocol allowing a two-way exchange. In a default mode the communication between the wheel unit and the remote monitoring and/or control device is carried out according to a first predetermined size and a first predetermined periodicity. Upon reception of a standard response message from the remote monitoring and/or control device, the wheel unit switches to an adjusted communication mode in which at least one of the communication parameters from among the size of the communicated message or the periodicity of communication is replaced by at least one other communication parameter having a second predetermined size and a second predetermined periodicity.

### CROSS REFERENCE TO RELATED APPLICATIONS

This application is the U.S. National Phase Application of PCT International Application No. PCT/EP2022/085771, filed Dec. 14, 2022, which claims priority to French Application No. 2200088, filed Jan. 6, 2022, the contents of such applications being incorporated by reference herein.

### FIELD OF THE INVENTION

The present invention relates to a method for adjusting communication parameters between a wheel unit and a remote monitoring and/or control device, the communication parameters possibly being the content of the communicated message and the periodicity of communication between a wheel unit and a remote monitoring and/or control device.

### BACKGROUND OF THE INVENTION

Nowadays, in a motor vehicle, it is known practice to mount an electronic measurement module comprising one or more sensors in each wheel in order in particular to detect an anomaly with the wheel. These sensors may, for example, be a tire inflation pressure sensor for the tire associated with the wheel and/or a wheel acceleration sensor.

These sensors, and in particular inflation pressure sensors, are mounted in electronic modules, called “wheel units”, of a tire pressure monitoring system, of the type known under the abbreviation “TPMS”.

FIG. 1 shows a tire monitoring system 101 in a motor vehicle 1C equipped with wheel units 3a to 3d and with a central electronic unit 2a for controlling the wheel units 3a to 3d, which is placed at a distance from the wheel units 3a to 3d, and, additionally, a mobile telephone in the possession of an authorized user serving as a device 2 for monitoring and/or controlling the wheel units 3a to 3d.

As is known, the wheel units 3a to 3d generally comprise a microprocessor, a memory, a transceiver, a supply battery, a pressure sensor and, if applicable, at least one other sensor such as a radial acceleration sensor capable of measuring the radial accelerations of the wheel or a temperature sensor, mounted on a support forming a printed circuit board or “PCB”.

According to the prior art, each wheel unit 3a to 3d associated with a wheel 102a to 102d of the motor vehicle 105 sends its measurements to a central electronic unit 2a for controlling the wheel units 3a to 3d that is integrated into the motor vehicle 1C and/or a mobile telephone 2 or technical equivalent provided with an application for communicating with the wheel units 3a to 3d, the central electronic unit 2a and the mobile telephone 2 being grouped together below under the name of device for remotely monitoring and/or controlling the wheel units 3a to 3d.

To this end, each wheel unit 3a to 3d transmits signals 106 to one or more devices 2, 2a for remotely monitoring and/or controlling the wheel units 3a to 3d, said signals comprising coded messages containing the measurements or other information processed and/or supplied by the wheel units 3a to 3d.

As other information, mention may be made of information relating to the geometry of the wheel, in particular of the rim and/or of the tire or to the history of the wheel, in particular its mileage, of specific application data, in particular an identification of the wheel units 3a to 3d, a location of the wheel on the vehicle 1C and other configurations of the system.

Finally, the processed and/or supplied information may relate to configuration parameters of the software application, or even the executable code in the case of remote reprogramming of the wheel units 3a to 3d.

Communication between the monitoring device 2, 2a and the wheel unit 3a to 3d, whether it is a mobile telephone or technical equivalent in the possession of an authorized user or the central electronic unit 2a for controlling the wheel units 3a to 3d that is integrated into the motor vehicle 1C, is carried out according to a communication protocol allowing a two-way short-range exchange of data using ultra-high-frequency, or UHF, radio waves according to a communication protocol of Bluetooth® type or an equivalent protocol.

To do this, the wheel unit 3a to 3d periodically sends basic signaling messages indicating its presence to any ultra-high-frequency wave communication device 2 located in an environment of the wheel unit 3a to 3d.

Such a communication device 2 is capable of intercepting a basic signaling message and of sending a standard response message to the wheel unit 3a to 3d, in particular, but not necessarily, when it is authorized to do so.

There is a problem due to the fact that the periodicity with which the signaling messages are sent from the wheel unit is too high, meaning that the communication between the wheel unit and the control device is not very responsive.

This applies mainly to a detection of the arrival near the motor vehicle of a user bearing the authorized device, and to exchanges between a wheel unit and the authorized device for the selection of commands or the communication of data from the wheel unit to the authorized device.

In order to obtain a good responsiveness as regards authorized devices seeking to connect to the wheel unit, it is recommendable to shorten the period of transmission of signaling messages from the wheel unit.

The major drawback is therefore the very high level of energy consumption implied by this shortening of the periodicities with which signaling messages are sent from the wheel unit.

The problem underlying the present invention is that of optimizing communications between at least one wheel unit associated with a wheel of a motor vehicle and a monitoring and/or control device located at a distance from said at least one wheel unit, while limiting an energy consumption in the wheel unit during the communications.

### SUMMARY OF THE INVENTION

To this end, an aspect of the present invention relates to a method for adjusting at least one of the communication parameters from among the size of the communicated message or the periodicity of communication between a wheel unit and a remote monitoring and/or control device, a communication between said monitoring device and the wheel unit being carried out according to a communication protocol allowing a two-way short-range exchange of data using ultra-high-frequency radio waves according to a two-way communication protocol, the wheel unit sending basic signaling messages indicating its presence to any ultra-high-frequency wave communication device located in an environment of the wheel unit, a communication device being capable of intercepting a basic signaling message and of sending a standard response message to the wheel unit, noteworthy in that:
in a mode referred to as “default”, the communication between the wheel unit and the remote monitoring and/or control device is carried out according to a first predetermined size and a first predetermined periodicity,
upon reception of a standard response message from the remote monitoring and/or control device, the wheel unit switches to a communication mode referred to as “adjusted” in which at least one of the communication parameters from among the size of the communicated message or the periodicity of communication is replaced by at least one other communication parameter characterized by a second predetermined size and a second predetermined periodicity, resulting in an adaptation of the energy consumption of the wheel unit,
the modes referred to as “default” and “adjusted” being predefined as a function of a running or non-running mode of the vehicle.

Strictly speaking, in a two-way protocol of Bluetooth® or equivalent type, in response to a basic signaling message from the wheel unit, the control device cannot send data signifying a request to replace the first periodicity with at least one shorter or longer second periodicity resulting in a more intense or less intense two-way exchange. Equally, the control device cannot send data signifying a request to replace the first size of the message with the or short or longer second message size. The control device can send only the equivalent of an acknowledgement of receipt of the basic signaling message sent by the wheel unit, without data included, which is called a standard response message. It is this acknowledgement of receipt which acts as a request to replace the first communication parameter with at least one other communication parameter when the wheel unit receives it, the wheel unit being programmed so that a standard response message sent by the control device and received by the wheel unit, in response to a signaling message sent by the wheel unit, signifies such a replacement request.

According to a first exemplary embodiment, when the vehicle is in a running mode:
the first size of the communicated message during the “default” mode is greater than the second size of the communicated message during the “adjusted” mode, and
the first periodicity of communication during the “default” mode is shorter than the second periodicity of communication during the “adjusted” mode.

This implementation makes it possible to meet the need according to which it is advantageous, in running mode, for the wheel unit to transmit messages with a possibility of defining non-communication times, while minimizing the energy consumption.

According to an advantageous exemplary embodiment, when the vehicle is in a running mode and the wheel unit sends a packet of several frames constituting the basic signaling message, as soon as the communication device receives a frame from the packet of frames constituting the basic signaling message sent by the wheel unit, it responds with a standard response message and the wheel unit, upon reception of this standard response message, cancels the sending of the subsequent frames of the packet of frames constituting the basic signaling message.

According to another exemplary embodiment, when the vehicle is in a non-running mode:
the first size of the communicated message during the “default” mode is smaller than the second size of the communicated message during the “adjusted” mode, and
the first periodicity of communication during the “default” mode is longer than the second periodicity of communication during the “adjusted” mode.

This implementation makes it possible to meet the need according to which it is advantageous, in non-running mode, for the communication of the wheel unit to be reduced to a minimum, with a possibility of triggering communications upon request, thus minimizing the energy consumption.

The information regarding the running or non-running mode of the vehicle and the sending by means of the control device of a standard response message forming only an acknowledgement of receipt in response to a signaling message sent by the wheel unit allows the wheel unit to know what action to take.

Thus, the period in which the wheel unit sends signaling messages becomes shorter or longer when a control device is detected in proximity to the wheel unit and the size of the signaling message sent by the wheel unit becomes shorter or longer when a control device is detected in proximity to the wheel unit. This allows the energy consumption of the wheel unit, this wheel unit incorporating a button cell, i.e. a battery of limited capacity, to be moderated while ensuring it operates optimally with accelerated two-way exchange when the authorized UHF device is close to the wheel unit.

According to one exemplary embodiment, upon reception of a standard response message from the remote monitoring and/or control device, a counter of the number of messages sent by the wheel unit in the “adjusted” mode is initialized, the “adjusted” mode being maintained as long as a value of the counter is lower than a predetermined threshold.

Thus, the “adjusted” mode is activated only temporarily.

According to one exemplary implementation when the vehicle is in a running mode, the “adjusted” mode is maintained as long as a variation in pressure measured in the tire of the wheel associated with the wheel unit is lower than a predetermined threshold.

According to one exemplary implementation when the vehicle is in a running mode, the “adjusted” mode is maintained as long as a variation in temperature measured in the tire of the wheel associated with the wheel unit is lower than a predetermined threshold.

Thus, detection of a significant variation in the temperature or in the pressure measured in the tire of the wheel associated with the wheel unit switches the wheel unit again to a “default” communication mode allowing it to re-establish rapid and complete communication with the control device. This is in particular important in running mode, during which these items of information are critical.

An aspect of the present invention provides a simple solution which makes it possible to solve the problems of consumption and availability of two-way communication, while maintaining the ability to control and trigger functions incorporated on the wheel unit, and does so by adjusting the size of the signaling messages and/or the periodicity with which said messages are sent by the wheel unit to the control device, according to the running or non-running mode of the vehicle.

An aspect of the present invention also relates to a wheel unit comprising an application-specific integrated circuit with a microprocessor for controlling the unit, the integrated circuit being provided with a microprocessor and storage means, the wheel unit also comprising a module for ultra-high-frequency communication according to a two-way communication protocol, noteworthy in that the integrated circuit implements an adjustment method as described above.

An aspect of the present invention finally relates to a communication device or a central monitoring and/or control device unit on board the motor vehicle comprising a chip capable of implementing the adjustment method as discussed above.

An aspect of the invention also relates to a computer program product comprising instructions for implementing the adjustment method presented by the present application when this method is implemented by a computer.

An aspect of the invention finally relates to a non-transient computer-readable storage medium on which code instructions for implementing the adjustment method presented by the present application are stored.

### BRIEF DESCRIPTION OF THE DRAWINGS

Other features, aims and advantages of aspects of the present invention will become apparent on reading the detailed description that follows and on examining the appended drawings provided by way of non-limiting examples, in which:

FIG. 1 is a schematic representation of a view of a tire monitoring system in a motor vehicle, the system comprising wheel units each associated with a wheel of the vehicle and a central monitoring and/or control unit integrated into the motor vehicle, the system being able to communicate remotely with an electronic device such as a mobile telephone via ultra-high-frequency, or UHF, waves, such a system being known from the prior art but being able to implement the adjustment method according to an aspect of the present invention,

FIG. 2 is a schematic representation of one exemplary embodiment according to the present invention of the method for adjusting communication parameters between a wheel unit and a remote monitoring and/or control device in the case where the vehicle is in a running mode,

FIG. 3 is a schematic representation of one exemplary embodiment according to the present invention of the method for adjusting communication parameters between a wheel unit and a remote monitoring and/or control device in the case where the vehicle is in a non-running mode.

In the description and the claims, and in all of these figures, identical or similar elements are denoted by identical or similar reference signs.

### DETAILED DESCRIPTION OF THE INVENTION

An aspect of the present invention relates to a method for adjusting at least one of the communication parameters between a wheel unit and a remote monitoring and/or control device.

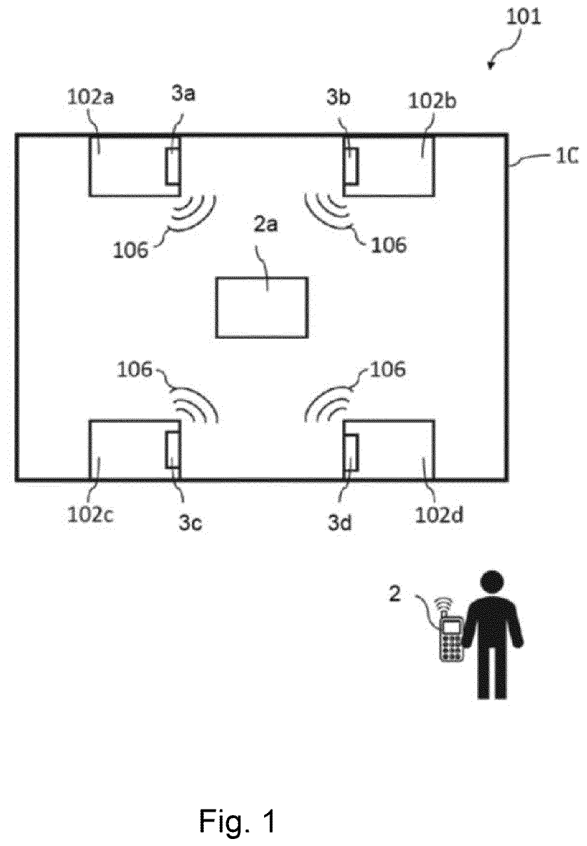

An aspect of the present invention will now be described with reference to FIGS. 1, 2 and 3. FIG. 1 has already been described in the introductory part of the present application. So as to avoid making the description needlessly cumbersome, what is stated for a wheel unit 3 is valid for all of the wheel units of a motor vehicle which were previously denoted 3a to 3d in FIG. 1.

Equally, in the remainder of the present description the remote monitoring and/or control device will be denoted 2 and may be a central electronic control unit fitted to a vehicle, a mobile telephone, a tablet computer, a smart watch or an equivalent electronic element that has downloaded an application allowing it to carry out a two-way exchange of information with the wheel units 3 that are each associated with a respective wheel of a motor vehicle.

In the context of an aspect of the present invention, as is moreover becoming increasingly widespread for communications involving one or more wheel units 3, a communication between the monitoring device 2 and the wheel unit 3 is carried out according to a communication protocol allowing a two-way short-range exchange of data using ultra-high-frequency radio waves, advantageously according to a communication protocol of Bluetooth® type.

For this purpose, the wheel unit 3 comprises a UHF module provided with a UHF transmitter and a UHF receiver, a microprocessor and storage means. The two-way exchanges may concern multiple UHF channels differing in UHF frequency. The most frequently used UHF communication may provide three channels, but there could be more. It has been possible to have up to 25 UHF channels for a single UHF module fitted to a wheel unit 3. For example, the signaling messages use three frequency channels.

The wheel unit 3 sends, according to first predetermined transmission parameters, basic signaling messages ADV indicating its presence to any ultra-high-frequency wave communication device 2 located in an environment of the wheel unit 3. This corresponds to the communication mode referred to as “default” MD.

According to an aspect of the invention, the transmission parameters are the size of the communicated message and/or a periodicity of communication between a wheel unit 3 and a remote monitoring and/or control device 2.

A UHF communication device is capable of intercepting a basic signaling message ADV and of sending a standard response message ADVs to the wheel unit 3. This standard response message ADVs does not contain data specific to a change in a parameter for transmission of signaling messages by the wheel unit, from among the size and the periodicity; rather, the fact alone that it is sent by the authorized device 2 and received by the wheel unit 3 is interpreted as a request to change at least one of the parameters for transmission by the wheel unit 3, which is programmed to interpret the standard response message in this way. The wheel unit then switches to an operating mode referred to as “adjusted” MA, during which the transmission parameters are modified with respect to the “default” mode MD.

The transmission parameters of the “default” mode MD and “adjusted” mode are defined as a function of the running or non-running operating modes of the vehicle 1C.

The detection of the running and non-running modes of the vehicle 1C is an item of information known to the wheel unit. For example, this information may be deduced from the acceleration information measured by an acceleration sensor, for example of the accelerometer type, which is normally fitted to the wheel unit 3.

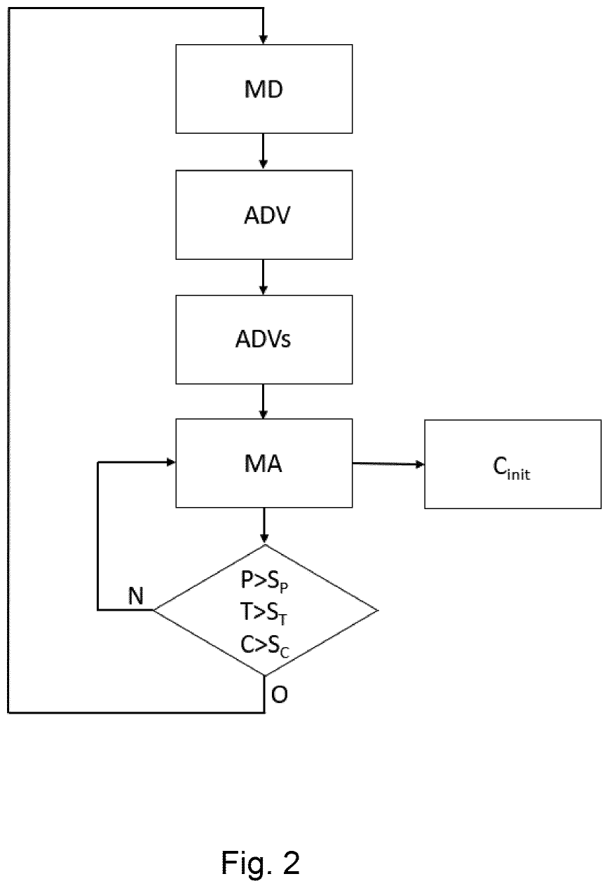

With reference to FIG. 2, the vehicle 1C is in a running mode: initially, the wheel unit 3 is in a “default MD” operating mode. The wheel unit 3 thus sends basic signaling messages ADV with a first periodicity that is relatively short, it for example being between 16 and 64 seconds, preferably about 32 seconds. In addition, the basic signaling messages ADV of the wheel unit 3 are complete.

When the communication device 2 responds to the basic signaling message ADV sent by the wheel unit 3 with a standard response message ADVs, the wheel unit 3 then switches to an operating mode referred to as “adjusted” MA. In this “adjusted” operating mode MA, the wheel unit then automatically replaces the first periodicity with a second periodicity that is longer than the first periodicity. For example, the second periodicity is between 16 and 64 seconds, and preferably of the order of 64 seconds.

In an alternative or combined manner, when the wheel unit 3 switches to the “adjusted” mode MA, the wheel unit 3 then also replaces the content of the transmitted messages such that the size of the messages transmitted by the wheel unit 3 is smaller than the size of the messages transmitted in the “default” mode. According to one exemplary embodiment, this reduction in size is achieved by the transmission of incomplete messages which are intended to notify the communication device 2 that the information transmitted in messages previously transmitted in the “default” mode MD is identical, such that the wheel unit 3 does not repeat them in their entirety.

Thus, since the information measured by the wheel unit 3 has not been modified, the wheel unit merely transmits reduced messages with a long periodicity in the “adjusted” mode MA.

More accurately, in running mode, upon reception of a standard response message ADVs transmitted by the control device 2, the wheel unit 3 may:
either modify the periodicity of the transmitted messages by adopting a longer periodicity,
or modify the size of the transmitted messages by transmitting messages with reduced content,
or modify the periodicity and the size for the purpose of reducing the energy consumption to the maximum possible extent.

Provision is specifically not made for the wheel unit 3 to simply stop transmitting messages because then the tire pressure monitoring system could perceive, wrongly, that the wheel unit has a communication fault.

One of the problems encountered when transmitting data between the wheel units 3 mounted on the wheels of motor vehicles and the central electronic control unit 2 results from there being zones without radiofrequency coverage, commonly referred to as “shadow zones” or “blackspots”, which consist of relative positions between the wheel units 3 and the central electronic control unit 2 at which communications between them are cut off or, at the very least, impaired. The current solutions implemented to overcome the drawbacks associated with their presence consist, overall, in multiplying the number of transmitted messages. It is therefore common for the wheel unit 3 to transmit a packet of several frames constituting a basic signaling message ADV, for example a packet of three frames that are phase-shifted so as to cover a wheel revolution (in other words with a phase shift corresponding to 360° divided by the number of frames).

Thus, according to another embodiment, in order to further improve the energy consumption, it is provided that as soon as the communication device 2 receives a frame from the packet of frames constituting the basic signaling message ADV sent by the wheel unit 3, it responds with a standard response message ADVs and the wheel unit 3, upon reception of this standard response message ADVs, cancels the sending of the subsequent frames of the packet of frames constituting the basic signaling message ADV.

However, in order to ensure optimal operation of the tire pressure monitoring system, it is provided that the wheel unit 3 switches back to the “default” mode MD so as to re-establish short periodicities for transmitting messages comprising complete information to the control device 2.

The return to the “default” operating mode MD of the wheel unit 3 is thus carried out instantaneously in the event of measurement of a variation in pressure P inside the tire of the wheel that is lower than a predetermined pressure variation threshold Sp.

The return to the “default” operating mode MD of the wheel unit 3 is also carried out directly in the event of measurement of a variation in temperature T inside the tire of the wheel that is lower than a predetermined temperature variation threshold ST.

This is represented in FIG. 2 by the output Y as “yes”. Otherwise, as represented in FIG. 2 by the output N as “no”, the wheel unit 3 remains in the “adjusted” operating mode MA.

According to another embodiment, the return to the default operating mode could also be initiated in the event of measurement of pressure or temperature values that are greater than respective predetermined thresholds.

This return of the wheel unit 3 to the “default” communication mode MD then allows it to re-establish rapid and complete communication with the control device 2 in order to notify the latter of any criticality of the parameters measured in the tires.

It is also provided that upon reception, by the wheel unit 3, of a standard response message ADVs from the remote control device 2, a counter C of the number of messages sent by the wheel unit in the “adjusted” mode MA is initialized Cinit. Thus, when the value of the counter C exceeds a predetermined threshold Sc (as represented in FIG. 2 by Y as “yes”), the wheel unit switches again to the “default” operating mode. Otherwise (as represented in FIG. 2 by N as “no”), the wheel unit 3 remains in the “adjusted” operating mode MA.

This thus allows the wheel unit 3 to regularly return to the “default” operating mode MD in the case where a significant variation in pressure or temperature would not be detected by said wheel unit.

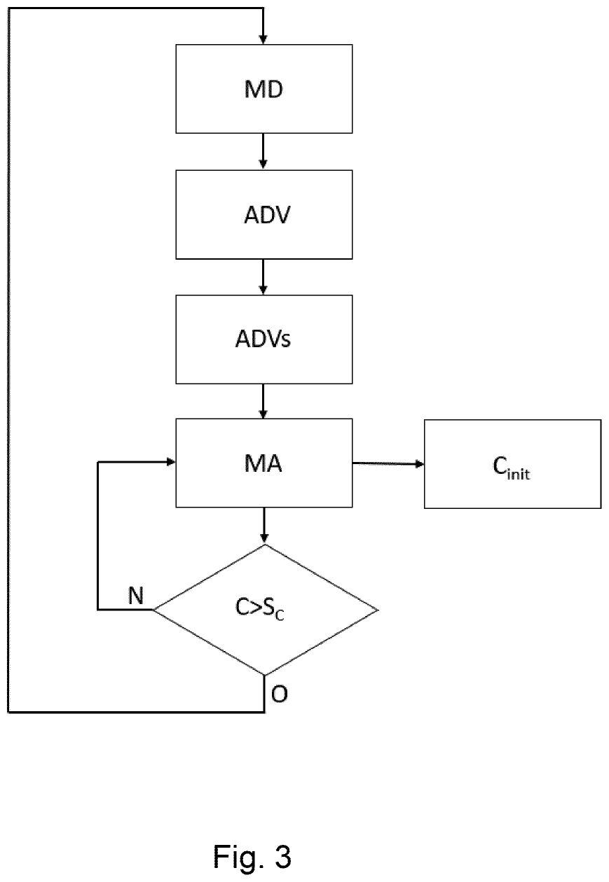

With reference to FIG. 3, a description will now be given of the adjustment method according to an aspect of the invention when the vehicle 1C is in a non-running mode, in other words when the vehicle 1C is at a standstill.

Initially, the wheel unit 3 is in a “default MD” operating mode. The wheel unit 3 thus sends basic signaling messages ADV with a first periodicity that is long, it for example being between 8 and 32 seconds, preferably about 16 seconds. In addition, the basic signaling messages ADV of the wheel unit 3 are reduced. For example, the wheel unit 3 transmits incomplete messages which are intended to notify the communication device 2 that the information transmitted in previous messages is identical, such that the wheel unit 3 does not repeat them in their entirety.

When the control device 2 responds to the basic signaling message ADV sent by the wheel unit 3 with a standard response message ADVs, the wheel unit 3 then switches to an operating mode referred to as “adjusted” MA. In this “adjusted” operating mode MA, the wheel unit then automatically replaces the first periodicity with a second periodicity that is shorter than the first periodicity. For example, the second periodicity is between 1 and 8 seconds, and preferably of the order of 4 seconds.

In an alternative or combined manner, when the wheel unit 3 switches to the “adjusted” mode MA, the wheel unit 3 then also replaces the content of the transmitted messages such that the size of the messages transmitted by the wheel unit 3 is greater than the size of the messages transmitted in the “default” mode. According to one exemplary embodiment, the wheel unit 3 transmits complete messages in the “adjusted” mode MA (in contrast to the incomplete messages of the “default” mode MD).

Thus, upon reception of a standard response message ADVs by the wheel unit, the communication with the control device 2 becomes more intense.

When the wheel unit 3 switches to the “adjusted” mode MA, a counter C of the number of messages sent by the wheel unit in the “adjusted” mode MA is initialized Cinit. Thus, when the value of the counter C exceeds a predetermined threshold Sc (as represented in FIG. 2 by Y as “yes”), the wheel unit switches again to the “default” operating mode. Otherwise (as represented in FIG. 2 by N as “no”), the wheel unit 3 remains in the “adjusted” operating mode MA.

This thus allows the wheel unit 3 to regularly return to the “default” operating mode MD with rapid and complete communication with the control device 2 in order to instantaneously and fully notify the latter.

It is noted that in non-running mode, the return of the wheel unit 3 to a “default” operating mode MD is not conditional upon a pressure or temperature measurement. Specifically, when the vehicle 1C is at a standstill, the information regarding any variation in pressure or temperature is not critical, which it is when the vehicle is running. Thus, the energy consumption is further reduced.

It is noted that the counter C, both in a running or non-running mode of the vehicle 1C, could alternatively be a time counter with the definition of a threshold time period for the “adjusted” mode MA beyond which the wheel unit 3 switches back to a “default” operating mode MD.

The method described above may be produced either in the application portion of software, or directly handled by the basic functionalities of an electronic chip, integrated, for example, into a wheel unit, and being able to be stored in ROM/flash-type memory.

This also applies to the ultra-high-frequency communication device and to the central electronic unit on board the motor vehicle that communicates with the wheel units.

An aspect of the present invention therefore also relates to a wheel unit comprising an application-specific integrated circuit with a microprocessor for controlling the unit, provided with a microprocessor and storage means, the integrated circuit of the wheel unit implementing an adjustment method as described above.

The wheel unit also comprises a module for ultra-high-frequency communication according to a communication protocol, for example of Bluetooth® type, with an antenna for communicating, both in reception and in transmission, with communication devices according to a protocol, for example of Bluetooth® type, and electronic components that are integrated at least partially, or otherwise, into the integrated circuit. For example, the communication module may comprise a microprocessor, a crystal-controlled clock and storage means.

An aspect of the invention also relates to a communication device or a central monitoring and/or control device unit on board the motor vehicle comprising a chip capable of implementing an adjustment method as described above.

1. A method for adjusting at least one of the communication parameters from among the size of the communicated message or the periodicity of communication between a wheel unit and a remote monitoring and/or control device, a communication between said monitoring device and the wheel unit being carried out according to a communication protocol allowing a two-way short-range exchange of data using ultra-high-frequency radio waves according to a two-way communication protocol, the wheel unit sending basic signaling messages indicating its presence to any ultra-high-frequency wave communication device located in an environment of the wheel unit, a communication device being capable of intercepting a basic signaling message and of sending a standard response message to the wheel unit, wherein:
in a mode referred to as “default”, the communication between the wheel unit and the remote monitoring and/or control device is carried out according to a first predetermined size and a first predetermined periodicity,
upon reception of a standard response message from the remote monitoring and/or control device, the wheel unit switches to a communication mode referred to as “adjusted” in which at least one of the communication parameters from among the size of the communicated message or the periodicity of communication is replaced by at least one other communication parameter characterized by a second predetermined size and a second predetermined periodicity, resulting in an adaptation of the energy consumption of the wheel unit,
the modes referred to as “default” and “adjusted” being predefined as a function of a running or non-running mode of the vehicle.

2. The adjustment method as claimed in claim 1, wherein, when the vehicle (1C) is in a running mode:
the first size of the communicated message during the “default” mode is greater than the second size of the communicated message during the “adjusted” mode, and
the first periodicity of communication during the “default” mode is shorter than the second periodicity of communication during the “adjusted” mode.

3. The adjustment method as claimed in claim 1, wherein, when the vehicle is in a running mode and the wheel unit sends a packet of several frames constituting the basic signaling message, as soon as the communication device receives a frame from the packet of frames constituting the basic signaling message sent by the wheel unit, it responds with a standard response message and the wheel unit, upon reception of this standard response message, cancels the sending of the subsequent frames of the packet of frames constituting the basic signaling message.

4. The adjustment method as claimed in claim 1, wherein, when the vehicle (1C) is in a non-running mode:
the first size of the communicated message during the “default” mode is smaller than the second size of the communicated message during the “adjusted” mode, and
the first periodicity of communication during the “default” mode is longer than the second periodicity of communication during the “adjusted” mode.

5. The adjustment method as claimed in claim 1, wherein, upon reception of a standard response message from the remote monitoring and/or control device, a counter of the number of messages sent by the wheel unit in the “adjusted” mode is initialized, the “adjusted” mode being maintained as long as a value of the counter is lower than a predetermined threshold.

6. The adjustment method as claimed in claim 1, wherein, in a running mode, the “adjusted” mode is maintained as long as a variation in pressure measured in the tire of the wheel associated with the wheel unit is lower than a predetermined threshold.

7. The adjustment method as claimed in claim 1, wherein, in a running mode, the “adjusted” mode is maintained as long as a variation in temperature measured in the tire of the wheel associated with the wheel unit is lower than a predetermined threshold.

8. A wheel unit comprising an application-specific integrated circuit with a microprocessor for controlling the unit, the integrated circuit being provided with a microprocessor and storage means, the wheel unit also comprising a module for ultra-high-frequency communication according to a two-way communication protocol, characterized in that the integrated circuit implements an adjustment method as claimed in claim 1.

9. A communication device or a central monitoring and/or control device unit on board the motor vehicle comprising a chip capable of implementing an adjustment method as claimed in claim 1.

10. A computer program product comprising instructions for implementing the adjustment method as claimed in claim 1, when this method is implemented by a computer.

11. A non-transient computer-readable storage medium on which code instructions for implementing the adjustment method as claimed in claim 1.
